(19) United States
(12) Patent Application Publication
(10) Pub. No.: US 2015/0054852 A1
(43) Pub. Date: Feb. 26, 2015

(54) IMAGE DISPLAY APPARATUS, DATA TRANSFER METHOD, AND RECORDING MEDIUM

(71) Applicant: SHARP KABUSHIKI KAISHA, Osaka (JP)

(72) Inventors: Atsushi OHNUMA, Osaka-shi (JP); Keisuke HASEGAWA, Osaka-shi (JP); Tsutomu Takahashi, Osaka-shi (JP); Toshio ONODERA, Osaka-shi (JP); Ai TERASHIMA, Osaka-shi (JP)

(21) Appl. No.: 14/329,150

(22) Filed: Jul. 11, 2014

(30) Foreign Application Priority Data
Aug. 26, 2013 (JP) 2013-174139

(51) Int. Cl. G09G 5/14; G09G 1/00

(52) U.S. Cl. CPC G09G 5/14; G09G 1/007
USPC 345/635

(57) ABSTRACT

An image display apparatus includes a communication portion that communicates with a plurality of information processing apparatuses in a wired or wireless manner, a display portion, a control portion that controls to receive images to be displayed on screens of the information processing apparatuses for each of the information processing apparatuses in the communication portion and display each of the received images on the display portion concurrently, and an operation portion that receives a data transfer operation between the information processing apparatuses by an operation for each of the images displayed on the display portion.

### CROSS-NOTING PARAGRAPH

This non-provisional application claims priority under 35 U.S.C. §119(a) on Patent Application No. 2013-174139 filed in JAPAN on Aug. 26, 2013, the entire contents of which are hereby incorporated herein by reference.

### FIELD OF THE INVENTION

The present invention relates to an image display apparatus, a data transfer method, and a recording medium, and more specifically, to an image display apparatus capable of displaying images from a plurality of information processing apparatuses concurrently, and a data transfer method in the image display apparatus, and a recording medium.

### BACKGROUND OF THE INVENTION

Conventionally, an image display apparatus capable of displaying images from a plurality of information processing apparatuses concurrently has been provided. For example, Japanese Laid-Open Patent Publication No. 2006-268442 describes that a list of additional data held by a mobile terminal apparatus is displayed on a screen of an external image display apparatus.

As a representative data transfer technology for performing data transfer between information processing apparatuses, (a) a data transfer technology using a file sharing service, (b) a data transfer technology by P2P (peer to peer), and (c) a data transfer technology according to a drag and drop operation between windows are cited.

In the technology (a) above, using a shared area in a server apparatus capable of access from each information processing apparatus, an information processing apparatus of a transfer source transmits data to the shared area so that an information processing apparatus serving as a transfer destination acquires the data from the shared area. In the technology (b) above, data is transferred by a unique protocol to a specific connection destination.

In the technology (c) above, a drag and drop operation is received between windows in a multi-window OS (Operating System), and at that time, such an operation event is monitored on the side of an application (process) that holds each window so that the process that holds the window performs transfer control when such an operation event is detected.

In the technology described in Japanese Laid-Open Patent Publication No. 2006-268442, however, it is impossible to perform data transfer between information processing apparatuses, and it cannot be said that a correspondence relation between a transfer source and a transfer destination at a time of a data transfer operation is intuitive in any technologies (a) to (c) above. In particular, in the technology (c) above, each window is a window of a different process, and the transfer destination or the transfer source is shown by a window name or the like, so that it is not enough to make a user recognize intuitively.

Further, in the technology (a) above, when creating the shared area, it is necessary to individually specify an information processing apparatus (or network) which is allowed to share in advance, and furthermore, an operation of transmitting to the shared area or an acquiring operation becomes necessary on the information processing apparatus side. In the technology (b) above, individual connection setting becomes necessary for each set composed of an information processing apparatus of a transfer source and an information processing apparatus of a transfer destination. In this manner, in the technologies (a) and (b) above, necessary operations place a burden on a user.

Further, in the technology (c) above, a process of the transfer source and a process of the transfer destination need to know a storage area (file path) of data to be transferred, but it is not seen whether the process of the transfer destination is able to access the path (that is, able to access the data) in advance, so that data transfer processing is likely to be failed even when being executed according to a data transfer operation.

### SUMMARY OF THE INVENTION

An object of the present invention is, in an image display apparatus to which a plurality of information processing apparatuses are connected, at a time of a data transfer operation for performing data transfer between the information processing apparatuses, to enable making a user recognize a correspondence relation between a transfer source and a transfer destination intuitively and making the user execute the data transfer with a simple operation.

An object of the present invention is to provide an image display apparatus including a communication portion that communicates with a plurality of information processing apparatuses in a wired or wireless manner, a display portion, and a control portion that controls to receive images to be displayed on screens of the information processing apparatuses for each of the information processing apparatuses in the communication portion and display each of the received images on the display portion concurrently, comprising an operation portion that receives a data transfer operation between the information processing apparatuses by an operation for each of the images displayed on the display portion.

Another object of the present invention is to provide the image display apparatus, wherein the data transfer operation is an operation for copying or moving of a file or a folder.

Another object of the present invention is to provide the image display apparatus, wherein when the data transfer operation is received by the operation portion, the control portion performs control to transfer data to be transferred through a buffer provided in the image display apparatus.

Another object of the present invention is to provide the image display apparatus, wherein when the data transfer operation is received by the operation portion, the control portion determines a transfer path based on a communication function that is available for the information processing apparatus of a transfer source and the information processing apparatus of a transfer destination, and performs control to transfer data to be transferred through the transfer path.

Another object of the present invention is to provide the image display apparatus, wherein the transfer path is a path that directly connects between the information processing apparatus of the transfer source and the information processing apparatus of the transfer destination or a path that connects between the information processing apparatus of the transfer source and the information processing apparatus of the transfer destination through a buffer provided in the image display apparatus.

Another object of the present invention is to provide the image display apparatus, wherein the operation portion has a touch panel provided in the display portion.

Another object of the present invention is to provide a data transfer method in an image display apparatus connected to a plurality of information processing apparatuses in a wired or wireless manner, comprising: a step that a control portion of the image display apparatus controls to receive images to be displayed on screens of the information processing apparatuses for each of the information processing apparatuses in a communication portion of the image display apparatus and display each of the received images on a display portion of the image display apparatus concurrently, a receiving step that an operation portion of the image display apparatus receives a data transfer operation between the information processing apparatuses by an operation for each of the images displayed on the display portion, and a step that the control portion executes data transfer according to the data transfer operation received at the receiving step.

Another object of the present invention is to provide a computer-readable non-transitory recording medium having a program to be executed by a computer of a control portion in an image display apparatus connected to a plurality of information processing apparatuses in a wired or wireless manner recorded therein, wherein the program is for executing a step of controlling to receive images to be displayed on screens of the information processing apparatuses for each of the information processing apparatuses and display each of the received images on a display portion of the image display apparatus concurrently, a receiving step of receiving a data transfer operation between the information processing apparatuses by an operation for each of the images displayed on the display portion, and a step of executing data transfer according to the data transfer operation received at the receiving step.

### BRIEF DESCRIPTION OF THE DRAWINGS

FIG. 1 is a view showing an exemplary configuration of a system composed of an image display apparatus according to the present invention and a plurality of information processing apparatuses connected thereto;

FIG. 2 is a flowchart explaining an example of data transfer processing in the system of FIG. 1;

FIG. 3 is a schematic view explaining an example of a data transfer operation in the data transfer processing of FIG. 2; and

FIG. 4 is a schematic view explaining an example of a flow of data in the data transfer processing of FIG. 2.

### PREFERRED EMBODIMENTS OF THE INVENTION

As an image display apparatus according to the present invention, which is an apparatus that is able to be connected to a plurality of information processing apparatuses, mobile terminal apparatuses such as a mobile telephone device (which also includes one called smartphone) and a mobile information terminal, and the like are cited, including PCs such as a tablet terminal, a mobile PC (Personal Computer), and a stationary PC. In addition, for the information processing apparatus as well, apparatuses such as PCs and mobile terminal apparatuses as described above are cited. In the system composed of the image display apparatus according to the present invention and the plurality of information processing apparatuses, the plurality of information processing apparatuses correspond to source devices, and the image display apparatus corresponds to a sink device that causes each of these source devices to display images to be displayed on screens of the source devices concurrently. Description will hereinafter be given for the image display apparatus according to various embodiments of the present invention, and an image display system composed of the apparatus and a plurality of information processing apparatuses, with reference to drawings.

### First Embodiment

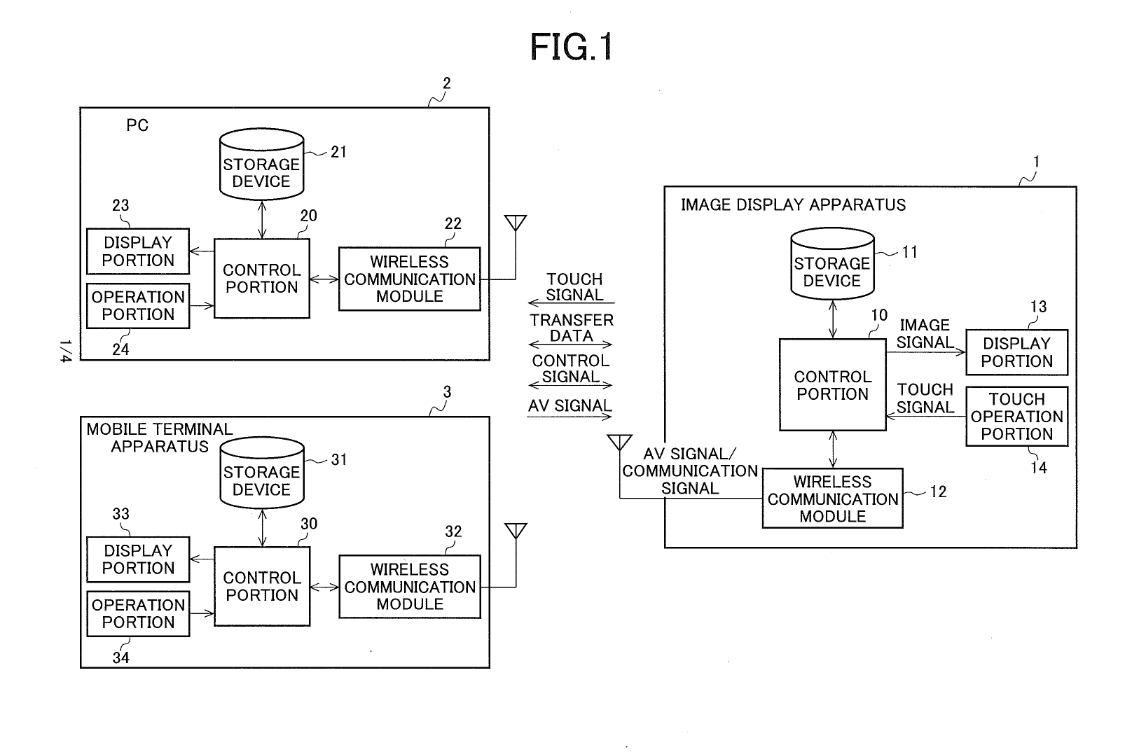

FIG. 1 is a view showing an exemplary configuration of the system composed of the image display apparatus according to the present invention and the plurality of information processing apparatuses connected thereto. The image display system exemplified in FIG. 1 (hereinafter, referred to as the present system) is provided with an image display apparatus 1, and a PC 2 and a mobile terminal apparatus 3 as an example of the plurality of information processing apparatuses. A combination of the information processing apparatuses is not limited to this example, and the number of the apparatuses to be connected may be three or more.

The image display apparatus 1 has a control portion 10 that controls a whole thereof, a storage device 11, a wireless communication module 12, a display portion 13 and a touch operation portion 14. The control portion 10 is a part for controlling a whole of the image display apparatus 1, and is composed of a control device such as a CPU (Central Processing Unit) or an MPU (Micro Processing Unit), a RAM (Random Access Memory) as a working area, and a storage device having a control program and various setting contents stored therein. As this storage device, a flash ROM (Read Only Memory), an EEPROM (Electrically Erasable and Programmable ROM), a hard disk and the like are cited, and the storage device 11 is also usable. Of course, a part of the control portion 10 is also able to be composed of dedicated hardwares.

When the image display apparatus 1 is a PC of Windows 8 (registered trademark, the same hereinafter), the control program includes an OS of Windows 8, and when the image display apparatus 1 is an Android (registered trademark, the same hereinafter) terminal, the control program includes an OS of Android.

The storage device 11 is a storage device such as an EEPROM and a hard disk, and is a module for saving image data to be displayed on the display portion 13 temporarily or saving various setting including arrangement information and the like when a plurality of images are displayed, which will be described below.

The image display apparatus 1 is provided with a communication portion that communicates with the PC 2 and the mobile terminal apparatus 3 in a wired or wireless manner. Description will be given by taking the wireless communication module 12 that communicates with the PC 2 and the mobile terminal apparatus 3 in a wireless manner as an example of the communication portion. However, a different communication method is able to be adopted between a part that performs communication with the PC 2 and a part that performs communication with the mobile terminal apparatus 3.

Moreover, as the communication portion, a different communication method is able to be adopted between a part that receives an output image from the information processing apparatuses such as the PC 2 and the mobile terminal apparatus 3 and a part that transmits and receives other control signals (signals showing other control command) such as control signals for data transfer processing described below. It is possible that, for example, AV (Audio Visual) (video and audio) signals, that is, a signal of the output image (output video signal) and an audio signal which is a signal of audio corresponding to the video are received by an HDMI (High-Definition Multimedia Interface; registered trademark, the same hereinafter) cable and other control signals are received by an Ethernet (registered trademark, the same hereinafter) module or a WiFi (registered trademark, the same hereinafter) module.

The display portion 13 is composed of a display panel such as a liquid crystal panel or an organic electro luminescence panel. Moreover, the image display apparatus 1 is provided with an operation portion for receiving user operations such as various setting operations and operations for execution of processing in the image display apparatus 1. This operation portion is composed of an operation key, a hardware keyboard (or software keyboard), a pointing device such as a mouse, and the like. Description will be given by taking the touch operation portion 14 allowing more intuitive operations as an example of the operation portion. The touch operation portion 14 is mainly composed of a touch panel provided in the display portion 13 and a GUI (Graphical User Interface) image to be displayed on the display portion 13. The touch panel is an example of the pointing device for operating a display.

The PC 2 has a control portion 20 that controls a whole thereof, a storage device 21, a wireless communication module 22, a display portion 23 and an operation portion 24. The control portion 20 is a part for controlling a whole of the PC 2, and is composed of, similarly to the control portion 10, a control device such as a CPU or an MPU, a RAM, and a storage device having a control program and various setting contents stored therein. As this storage device, a flash ROM, an EEPROM, a hard disk and the like are cited, and the storage device 21 is also usable. Of course, a part of the control portion 20 is also able to be composed of dedicated hardware. When the PC 2 is a PC of Windows 8, the control program includes an OS of Windows 8.

The storage device 21 is a storage device such as an EEPROM and a hard disk, and is a module for saving image data to be displayed on the display portion 23 temporarily or saving various setting. The PC 2 is provided with a communication portion that communicates with the image display apparatus 1 in a wired or wireless manner. Description will be given by taking the wireless communication module 22 that communicates with the image display apparatus 1 in a wireless manner as an example of the communication portion.

The display portion 23 is composed of a display panel such as a liquid crystal panel or an organic electro luminescence panel. The operation portion 24 is composed of an operation key, a hardware keyboard (or software keyboard), a pointing device, and the like, for receiving user operations such as various setting operations and operations for execution of processing in the PC 2. Of course, the touch operation portion similar to the touch operation portion 14 is also able to be adopted as the operation portion 24.

The mobile terminal apparatus 3 has a control portion 30 that controls a whole thereof, a storage device 31, a wireless communication module 32, a display portion 33 and an operation portion 34. The control portion 30 is a part for controlling a whole of the mobile terminal apparatus 3, and is composed of, similarly to the control portion 10, a control device such as a CPU or an MPU, a RAM, and a storage device having a control program and various setting contents stored therein. As this storage device, a flash ROM, an EEPROM, a hard disk and the like are cited, and the storage device 31 is also usable. Of course, a part of the control portion 30 is also able to be composed of dedicated hardware. When the mobile terminal apparatus 3 is an Android terminal, the control program includes an OS of Android.

The storage device 31 is a storage device such as an EEPROM and a hard disk, and is a module for saving image data to be displayed on the display portion 33 temporarily or saving various setting. The mobile terminal apparatus 3 is provided with a communication portion that communicates with the image display apparatus 1 in a wired or wireless manner. Description will be given by taking the wireless communication module 32 that communicates with the image display apparatus 1 in a wireless manner as an example of the communication portion.

The display portion 33 is composed of a display panel such as a liquid crystal panel or an organic electro luminescence panel. The operation portion 34 is composed of an operation key, a hardware keyboard (or software keyboard), a pointing device, and the like, for receiving user operations such as various setting operations and operations for execution of processing in the mobile terminal apparatus 3. Of course, the touch operation portion similar to the touch operation portion 14 is also able to be adopted as the operation portion 34.

Next, description will be given for a main feature of the present invention.

The control portion 10 of the image display apparatus 1 controls to receive images (image information) to be displayed on screens of the information processing apparatuses for each of the information processing apparatuses in the wireless communication module 12, and controls (display-controls) to display each of the received images on the display portion concurrently. That is, current display screens of the PC 2 and the mobile terminal apparatus 3 in which communication is established by the wireless communication module 12 are displayed on the display portion 13.

However, actually, by power-saving setting of the PC 2 and the mobile terminal apparatus 3, screen display may be off on the display portion 23 and the display portion 33 of the PC 2 and the mobile terminal apparatus 3 serving as sources of each image being displayed on the display portion 13. Alternatively, power-saving setting may be instructed to the PC 2 and the mobile terminal apparatus 3 after the images are displayed in the image display apparatus 1.

In the case of displaying concurrently, it is preferable that images of the information processing apparatuses (the PC 2 and the mobile terminal apparatus 3) in connection are divided by the number of the information processing apparatuses in connection to be displayed (in other words, displayed in another area). A dividing and displaying method may be determined in advance according to the number, or it may be configured such that arrangement and a size thereof are able to be changed by a user operation.

It may be configured so that display control as described above is also realized by the control program in the control portion 10. That is, the control program of the control portion 10 incorporates a program for such display control as a part of an OS or on the OS. For example, as a part of the GUI image in the touch operation portion 14, images output from the PC 2 and the mobile terminal apparatus 3 may be synthesized on two screens and displayed.

Then, the touch operation portion 14 in the image display apparatus 1 receives a data transfer operation between the information processing apparatuses (between the PC 2 and the mobile terminal apparatus 3 in the example of the present system) by an operation for each image (the image output from the PC 2 and the image output from the mobile terminal apparatus 3 in the example of the present system) displayed on the display portion 13. As described above, an operation portion including hardware such as a pointing device is also able to be adopted instead of the touch operation portion 14.

The operation for the images refers to an operation that an object included in the images output from the PC 2 and the mobile terminal apparatus 3 (the image to be displayed on the display portion 23 of the PC 2 and the image to be displayed on the display portion 33 of the mobile terminal apparatus 3) is selected, and the control portion 10 provides information of a touch position to a source device of each image so that the object is recognized as a data transfer target.

Moreover, the data transfer operation is an operation of transferring an object such as a file or a folder, which corresponds to an operation for copying or moving the object. The copying operation and the moving operation may be defined in advance to have a different operation method. For example, it is possible that an operation of dragging and dropping the data transfer target with one finger is the copying operation and an operation of dragging and dropping the data transfer target with two fingers is the moving operation. Further, it is also possible that an operation of dragging and dropping the data transfer target after tapping it once is the copying operation and an operation of dragging and dropping without tapping is the moving operation.

Of course, it is possible to adopt such an operation method that a pointing device is used as described above to thereby select the data transfer target and display a menu screen by right click or the like for selecting whether to copy or cut (move). In this case, a paste operation may be performed similarly by right click or the like at a position of a transfer destination.

Moreover, though description has been given assuming that each image is divided and displayed, a part or all of display areas of each image may be displayed so as to be overlapped. Ina configuration where the data transfer operation is received by a touch operation, however, it is set that any image is shown at least partially. Further, for the data transfer operation of an object in an image which is displayed as an upper layer window into an image which is displayed as a lower layer window, the data transfer operation may be started (object is selected) for dragging and dropping to a position of the lower layer window. In this case, at a stage where a finger moves to the position of the lower layer window during dragging, the windows may be displayed by switching the upper layer and the lower layer.

In this manner, the touch operation portion 14 is configured so as to be able to instruct the data transfer operation between the PC 2 and the mobile terminal apparatus 3 based on the image of the PC 2 and the image of the mobile terminal apparatus 3, which are displayed.

Further, the control program in the control portion 10 incorporates a program for executing data transfer processing according to such a data transfer operation (data transfer processing program) as a part of an OS or on the OS.

When receiving the data transfer operation by the touch operation portion 14, the control portion 10 in the present embodiment performs control to transfer data serving as the transfer target through a buffer (for example, the storage device 11) provided in the image display apparatus 1.

This makes it possible to execute data transfer even if a communication method between the image display apparatus 1 and the PC 2 and a communication method between the image display apparatus 1 and the mobile terminal apparatus 3 are different. More specifically, differently from the technology (c) above, even when it is not seen whether the process of the transfer destination is able to access the path (that is, able to access the data) in advance, it is possible to execute the data transfer processing according to the data transfer operation.

As above, according to the present invention, in the image display apparatus to which the plurality of information processing apparatuses are connected, at a time of the data transfer operation for performing data transfer between the information processing apparatuses, it becomes possible to make a user recognize a correspondence relation between the transfer source and the transfer destination intuitively, compared to the technologies (a) to (c) above. In particular, in the technology (c) above, each window is a window of a different process, and the transfer destination or the transfer source is shown by a window name or the like, but in the present invention, images of the screens output from the information processing apparatuses are displayed and the data transfer operation is performed on these images, thus making it possible to make the user recognize the transfer destination and the transfer source intuitively. In addition, according to the present invention, operations placing a burden on the user, which are necessary in the technologies (a) and (b) above, become unnecessary, so that it is possible to make the user execute the data transfer with a simple operation.

For example, display screens of a plurality of tablet PCs with Windows 8 and a display screen of a smartphone are displayed on the common image display apparatus 1 side by side and the data transfer operation of a file that a certain tablet PC has, which is displayed on the image display apparatus 1, to another tablet PC is received, thus making it possible to transfer the file that the tablet PC has to another tablet PC with a simple operation.

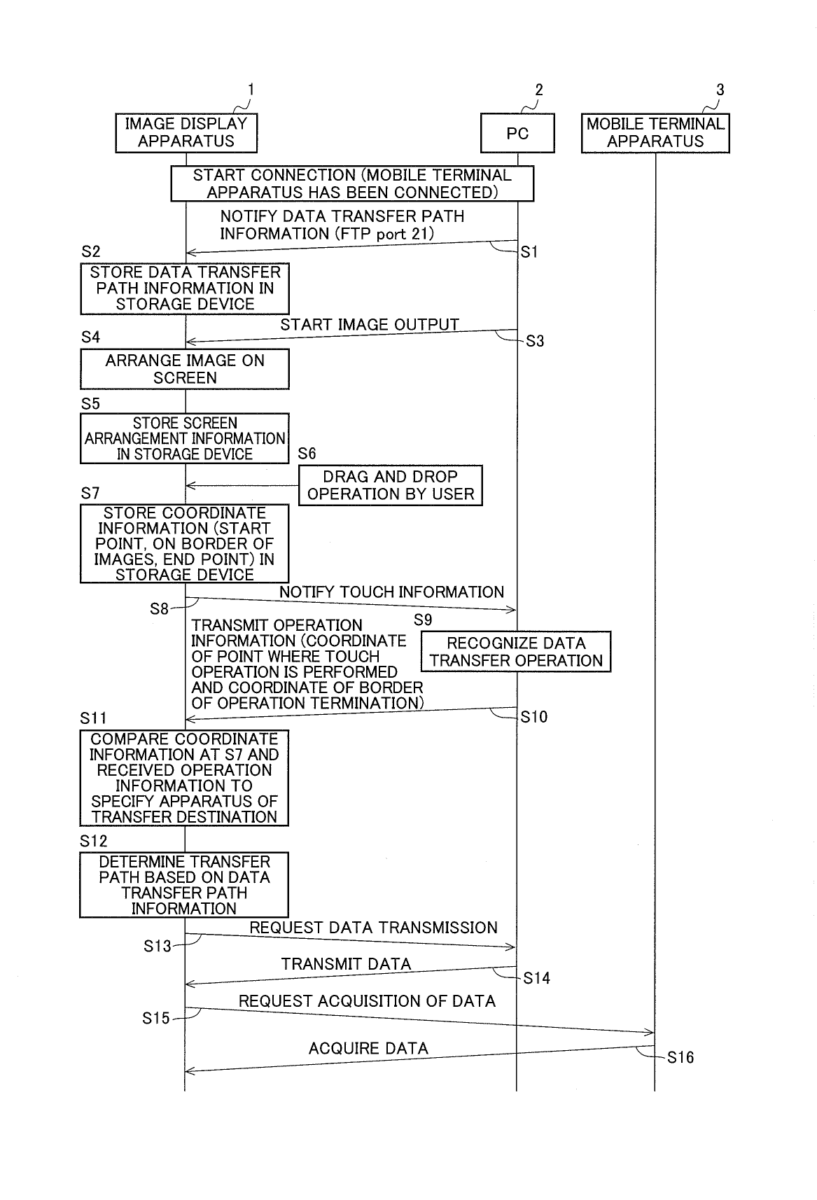

Description will hereinafter be given for a more specific example of the data transfer processing with reference to FIG. 2 to FIG. 4.

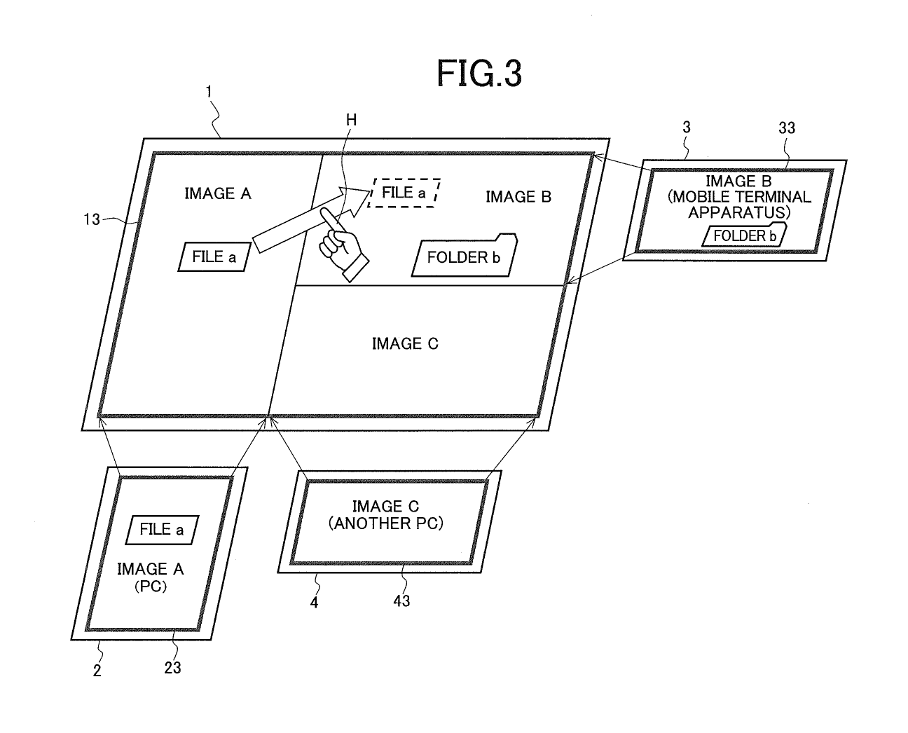

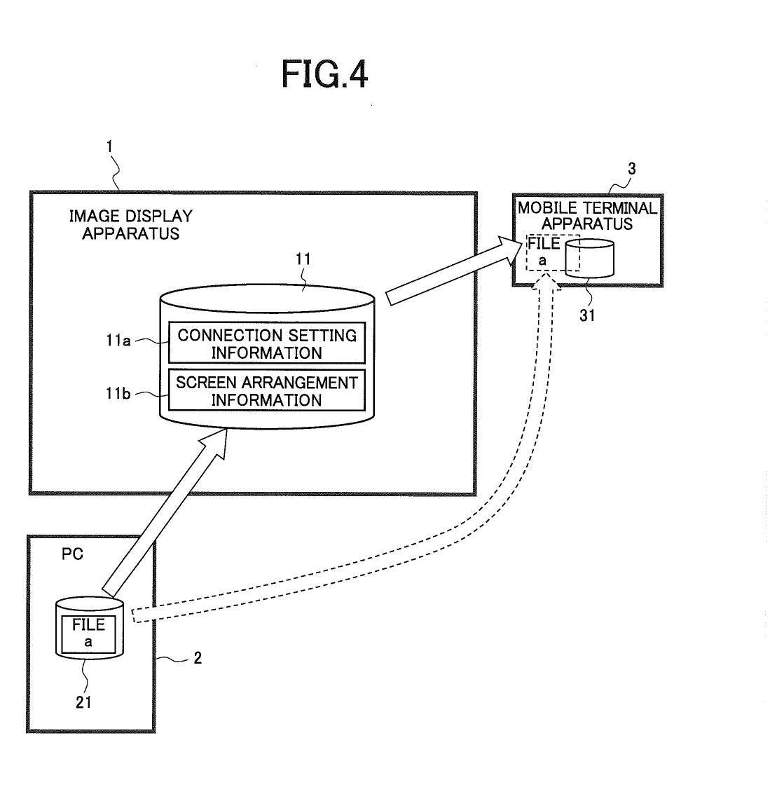

FIG. 2 is a flowchart explaining an example of the data transfer processing in the system of FIG. 1. FIG. 3 is a schematic view explaining an example of a data transfer operation in the data transfer processing of FIG. 2, and FIG. 4 is a schematic view explaining an example of a flow of data in the data transfer processing of FIG. 2. Description will be given assuming that the mobile terminal apparatus 3 has been connected to the image display apparatus 1, for simplicity of description.

First, the image display apparatus 1 acquires configuration information regarding an information processing apparatus serving as a source device for the data transfer processing. Specifically, when connection of the image display apparatus 1 and the PC 2 starts, the control portion 10 acquires data transfer path information (supported protocol or the like) on the PC 2 side through the wireless communication module 12 by notification from the PC 2 (step S1).

For example, to describe a case where P2P connection by WiFi wireless communication is used, the control portion 10 of the image display apparatus 1 finds (recognizes) the PC 2 by a user operation for the image display apparatus 1 or the PC 2 and executes connection processing. The control portion 10, in the connection processing, receives notice from the PC 2 that a communication path is an IP (Internet Protocol) base, and establishes the communication path. Further, when the IP-based communication path is used, for example, a protocol type and a port number (for example, FTP, port 21), as well as availability of server operation/client operation are notified as the data transfer path information. In the case of the IP-based communication path, various information is transmitted using a port number which is determined in advance.

Moreover, as a representative exemplary configuration that the communication path is not the IP-based, a case where the information processing apparatuses and the image display apparatus 1 are connected in a wired manner by a USB (Universal Serial Bus; registered trademark, the same hereinafter) cable and an HDMI cable is considered. In this case, an image signal is treated by the HDMI cable and other signals (touch signal, transfer data signal and control signal) are treated by the USB cable. The touch signal, the transfer data signal and the control signal are able to be treated using an HID (Human Interface Device) class, a Mass Storage class, and a Vendor Specific class of the USB, respectively.

Next, the control portion 10 stores this data transfer path information in the storage device 11 (step S2), and upon start of image output from the PC 2 (step S3), determines screen arrangement information of each information processing apparatus to display on the display portion 13 (step S4), and stores the screen arrangement information in the storage device 11 (step S5). As the screen arrangement information, a display size and an arrangement coordinate (at a point in the upper left) of an image in a display screen on the display portion 13 of the image display apparatus 1 may be stored for each image.

Note that, the same processing as steps S1 to S5 is executed in the image display apparatus 1 also in the case of connection with the mobile terminal apparatus 3. In the image display apparatus 1, each time the number of the information processing apparatuses targeted for display is increased or decreased, the screen arrangement information may be changed.

With processing like steps S1 to S5, the output image from the PC 2 and the output image from the mobile terminal apparatus 3 are displayed in a divided manner on the display portion 13. FIG. 3 shows an exemplary display screen in the display portion 13 when three information processing apparatuses are connected by further increasing the number of the information processing apparatuses. In this example, an image A displayed on the display portion 23 of the PC 2 is displayed on the left side of the display portion 13, an image B displayed on the display portion 33 of the mobile terminal apparatus 3 is displayed on an upper part of the right side of the display portion 13, and an image C displayed on a display portion 43 of another PC 4 is displayed on a lower part of the right side of the display portion 13.

Then, in such a state, connection setting information 11a and screen arrangement information 11b are stored in the storage device 11 as shown in FIG. 4. The connection setting information 11a is information showing connection setting of the image display apparatus 1 and each information processing apparatus, which includes at least the data transfer path information.

In such a display state, an operation of dragging and dropping an object (in this example, file a) of the PC 2 with a finger H by a user as shown with an arrow in FIG. 3 is received by the touch operation portion 14 (step S6). Note that, the drag and drop operation refers to an operation of moving an icon indicating the file a to another position (for example, onto a display area of another image) while pressing it. Here, coordinate information input by touching from the touch operation portion 14 is transmitted to a corresponding information processing apparatus as coordinate information which is normalized appropriately based on information showing a display size of an image in the display screen of the display portion 13, which is included in the screen arrangement information.

When the drag and drop operation received at step S6 is one reaching to a display area of another image, the control portion 10 performs data transfer operation for moving the file a in the PC 2 to the mobile terminal apparatus 3 accordingly. Such data transfer processing will be described specifically.

The control portion 10 stores coordination information in the storage device 11 as to the drag and drop operation in which straddling image display areas (in this example, stepping over a border between both areas from a display area of the image A to a display area of the image B) is detected in the touch operation portion 14 (step S7). Note that, since coordinate information may be stored only for the newest straddling, coordination information for past strides may be deleted.

As this coordinate information, a start point of the drag and drop operation, a point on a border of images and an end point are cited. At a timing when the end point is determined, this coordinate information is stored as for an event of the data transfer operation. However, it may be detected as the drag and drop operation at a time when crossing the image border and the end point may be displaced as the drag progresses. Moreover, with the coordinate information, a time when each point is touched (operation time) is stored together. A system time of the control portion 10 may be used as the operation time.

After step S7, the control portion 10 transmits touch information (touch information of the data transfer operation) to the information processing apparatus (PC 2 in the example of FIG. 3) corresponding to the display screen which includes the start point of the touch operation (input coordinate point) at the touch operation portion 14 (step S8). The touch information transmitted here may be a series of information showing the drag and drop operation, but may be only the coordination information stored in the storage device 11. Note that, the touch information of the data transfer operation may be delivered at a time when straddling the image border occurs (or after that), and in this case, the information processing apparatus of the transfer destination is not defined at a time before straddling the border occurs and the data transfer processing is not started.

The control portion 20 of the PC 2 receives the touch information of the data transfer operation through the wireless communication module 22. Upon this reception, the control portion 20 then recognizes that an event of the data transfer operation is caused (step S9). Subsequently, the control portion 20 of the PC 2 transmits the touch information which is sequentially received from the touch operation portion 14 during the data transfer operation (hereinafter, referred to as operation information) to the image display apparatus 1 (step S10). This operation information includes a coordinate of the start point of the touch operation and a coordinate of termination of the touch operation (that is, coordinate of border of operation termination).

The control portion 10 compares the received operation information and event information which straddles the border (coordinate information held at step S7), and when the start point matches with the information showing the image border as well as time and date when the touch operation is performed (the operation time) and the corresponding communication time (time and date when the operation information is received) are within a specific time, judges both of them as the same event. Being the same event shows that termination of the user operation is included in the display area of the information processing apparatus serving as the transfer destination (the mobile terminal apparatus 3 in the example of FIG. 3), that is, the termination coordinate shows the straddling.

Thus, at a time when it is defined that the termination coordinate shows the straddling (that is, at a time when it is able to be judged as being the same event), the control portion 10 specifies the information processing apparatus of the transfer destination based on the information showing the termination coordinate and the screen arrangement information (step S11). In the example of FIG. 3, since the image A is in contact with the image B at the termination coordinate on the arrow in the image A, it is possible to specify that the information processing apparatus of the transfer destination is the mobile terminal apparatus 3 which is a source device of the image B.

Next, the control portion 10 determines a transfer path based on the data transfer path information between the information processing apparatuses of the transfer source and the transfer destination (step S12). In the present embodiment, since it is assumed that the transfer path is through the buffer of the image display apparatus 1, as exemplified with solid arrows in FIG. 4, transfer paths from the transfer source to the buffer and from the buffer to the transfer destination are determined.

The control portion 10 then issues a data transmission request to the transfer source based on the data transfer path information of the information processing apparatus of the transfer source and the image display apparatus 1 (step S13). Thus, the data transmission request includes an address of a connection destination, a file path, and the termination coordinate.

The address of the connection destination is an address of the image display apparatus 1, and the file path is a path for the buffer (which is able to be exemplified by the storage device 11 as described above) of the image display apparatus 1 which is a relay destination. In addition, at a current stage where the data transfer operation is received, the information processing apparatus of the transfer source (PC 2 in FIG. 3) is in a state where the file a is moved to the termination coordinate. Thus, by including the termination coordinate in the data transmission request, it is possible to specify data to be transferred (file a in this example).

As to steps S12 and S13, considered is a case where each information processing apparatus is in the same IP network with the image display apparatus 1 as an access point in advance and corresponds to an FTP protocol (client). In this case, the image display apparatus 1 operates as the FTP server, thereby relaying the data transfer. That is, the image display apparatus 1 determines a protocol and a port number from the data transfer path information, and requests the information processing apparatus of the transfer source to transmit data to an IP address of the image display apparatus 1.

Subsequently, the control portion 10 of the image display apparatus 1 receives the data to be transferred (data of file a) (step S14), and at a stage where the reception is completed, requests the information processing apparatus of the transfer destination (mobile terminal apparatus 3) to acquire the data from the IP address of the image display apparatus 1 (step S15).

This request (data acquisition request) includes the path (file path) to the buffer of the image display apparatus 1 which is the relay destination, the termination coordinate and the coordinate of the end point stored at step S7, in addition to the address of the connection destination exemplified by the IP address of the image display apparatus 1. The termination coordinate is required for specifying data to be transferred, but only a file name may be included in the file path instead.

The mobile terminal apparatus 3 acquires the data of the file a from the buffer of the image display apparatus 1 in accordance with this data acquisition request (step S16). Based on the coordinate of the end point included in the data acquisition request, the mobile terminal apparatus 3 which has acquired this data displays an icon of the received data (data of file a) at a corresponding coordinate position on the GUI image, and further stores the data in the corresponding storage device 31 to complete the data transfer processing. Note that, when it is not allowed to write in due to capacity shortage of an area at the storage destination or the like, a pop-up image by which an arbitrary writable storage area is able to be selected may be displayed, and the like.

Moreover, in the example of FIG. 3 described above, since description has been given assuming that the file a is arranged in a predetermined storage area (for example, on a desktop or just below root) of the mobile terminal apparatus 3, the data transfer processing is possible by grasping only that the transfer destination is the mobile terminal apparatus 3 in the image display apparatus 1. However, the transfer destination may be a storage area designated by a user with the data transfer operation in the mobile terminal apparatus 3. For example, when the file a is dropped on a folder b, the file a is controlled to be transferred into the folder b.

Further, it may be configured such that, when a position where the drag operation is stopped temporarily corresponds to a non-folder area (here, other than a display area of the folder b) of the desktop, the transfer is performed temporarily to the predetermined storage area, and after that, when being dragged and dropped to the display area of the folder b, the transfer is further executed into the folder b in the storage device 31 of the mobile terminal apparatus 3.

As shown from the example of such temporal stopping of the operation, a timing when judging of whether or not to be the data transfer operation in the present invention is executed may be at any time interval.

However, it is desirable to configure so that the icon of the file a, which is being dragged, matches with the drag operation as much as possible.

### Second Embodiment

As to the image display apparatus 1 according to a second embodiment of the present invention, only points different from the first embodiment are described, and the description of the first embodiment is basically able to be used as to other points including application examples as well.

When receiving a data transfer operation by the touch operation portion 14, the control portion 10 in the second embodiment determines a transfer path based on a communication function that is available in the information processing apparatus of a transfer source and the information processing apparatus of a transfer destination. This determination processing corresponds to processing executed instead of step S12 of FIG. 2, for example.

More specifically, as the data transfer path information in the connection setting information 11a, information showing the available communication function (for example, available protocol among transfer protocols such as HTTP or FTP) may be acquired from each information processing apparatus to be stored, and the communication function which matches between the information processing apparatuses of the transfer source and the transfer destination may be selected.

Of course, it is set that matching means that the communication function makes it possible to exchange data directly between the transfer source and the transfer destination. For example, when the transfer source and the transfer destination are connected by a USB cable, direct exchange of data is possible between the transfer source and the transfer destination if being compatible with USB On-The-Go, so that it is necessary to judge whether such compatibility is made. Further, when a plurality of communication functions match, one having a high transfer speed is selected more preferably.

On the other hand, when there is no communication function which matches, for example, a pop-up image that prompts a user to directly connect the transfer source and the transfer destination may be displayed on the display portion 13.

Then, the control portion 10 performs control so that the data to be transferred is transferred through the transfer path. With such control as well, it is possible to select an optimal transfer path (that is, possible to select an optimal transfer protocol) even if the communication method between the image display apparatus 1 and the PC 2 and the communication method between the image display apparatus 1 and the mobile terminal apparatus 3 are different, so that less labor of establishing connection is required.

Taking an example of this control, the control portion 10 performs processing as follows, instead of the processing subsequent to step S13 of FIG. 2. First, in accordance with the determined transfer path, the control portion 10 issues, to the information processing apparatus of the transfer source (PC 2 in the example of FIG. 3), a data transmission request for transferring target data to the information processing apparatus of the transfer destination (mobile terminal apparatus 3 in the example of FIG. 3).

The data transfer request issued here may include an address of a connection destination, a file path, the termination coordinate, and the coordinate of the end point. In this case, the address of the connection destination is an address for the mobile terminal apparatus 3 which is the transfer destination, and as the file path, the predetermined storage area in the mobile terminal apparatus 3 which is the transfer destination or a storage area acquired by feedback of the touch information to the transfer destination based on the coordinate of the end point is cited. The termination coordinate is required for specifying data to be transferred, but only a file name may be included in the file path instead.

The PC 2 which has received this data transfer request transfers the data to be transferred to the mobile terminal apparatus 3 of the transfer destination in accordance with the request. Based on the coordinate of the end point included in the data transfer request, the mobile terminal apparatus 3 which has acquired this data displays an icon of the received data (data of file a) at a corresponding coordinate position on the GUI image, and further stores the data in the corresponding storage device 31 to complete the data transfer processing. Note that, when it is not allowed to write in due to capacity shortage of an area at the storage destination or the like, a pop-up image by which an arbitrary writable storage area is able to be selected may be displayed, and the like.

### Third Embodiment

As to the image display apparatus 1 according to a third embodiment of the present invention, only points different from the second embodiment are described, and the description of the second embodiment is basically able to be used as to other points including application examples as well.

The control portion 10 in the third embodiment uses a path which directly connects between the information processing apparatus of a transfer source and the information processing apparatus of a transfer destination (path shown by a dotted arrow in FIG. 4) or a path which connects between the information processing apparatus of the transfer source and the information processing apparatus of the transfer destination through the buffer provided in the image display apparatus 1 (a path shown by a solid arrow in FIG. 4), as the transfer path in the second embodiment.

That is, when receiving a data transfer operation by the touch operation portion 14, the control portion 10 in the present embodiment performs control to transfer data to be transferred between the information processing apparatus of the transfer source and the information processing apparatus of the transfer destination directly or through the buffer provided in the image display apparatus 1.

To describe by using FIG. 2, when receiving the data transfer operation by the touch operation portion 14, the control portion 10 determines the transfer path based on the available communication function similarly to the second embodiment, whereas in the present embodiment, differently from the second embodiment, when there is no communication function which matches, performs communication through the buffer of the image display apparatus 1.

The processing when communication is performed through the buffer of the image display apparatus 1 is as described for the first embodiment. In the example of FIG. 4, when not only each information processing apparatus is in the same IP network with the image display apparatus 1 as an access point in advance and corresponds to an FTP protocol (client), but also it is desired to execute data transfer between two information processing apparatuses which have no P2P connection path, the transfer path through the buffer of the image display apparatus 1 is determined. That is, in this example, since neither of the information processing apparatuses of the transfer source/transfer destination have a server function, the transfer path is determined so as to relay the data transfer by operating the image display apparatus 1 as an FTP server.

Moreover, as information showing connection setting between the image display apparatus 1 and each information processing apparatus in the connection setting information 11a, information showing which of the path for direct connection and the path through the buffer is to be adopted or any path is possible may be stored to determine the transfer path based on the information, and in this case, the information is preferably able to be changed by user setting.

As above, according to the third embodiment, it is possible to select an optimal transfer path (that is, possible to select an optimal transfer protocol) more reliably than the second embodiment, so that less labor of establishing connection is required.

### Exemplary Configuration Common to First to Third Embodiments

The image display apparatus 1, the PC 2 and the mobile terminal apparatus 3 exemplified in FIG. 1, except for the display portions 13, 23 and 33 thereof, are able to be realized by, for example, hardware including peripheral devices such as a microprocessor (or DSP: Digital Signal Processor), a memory, a bus and an interface, and software (such as control program described above) executable on this hardware. A part of the hardware is able to be mounted as an integrated circuit/IC chip set, and in this case, the software may be stored in this memory.

Moreover, an object of the present invention is achieved as well when a recording medium having a program code of the software for realizing functions in the various embodiments described above recorded therein is supplied to each apparatus (the image display apparatus and the information processing apparatuses) and the program code is executed by a computer such as a microprocessor or a DSP in each apparatus.

In this case, the program code itself of the software is to realize functions of the various embodiments described above, and even the program code itself or the recording medium having the program code recorded therein (external recording medium or internal storage device) are able to constitute the present invention by reading and executing the code on the control side. Examples of an external recording medium include various media such as an optical disk including a CD-ROM, or a DVD-ROM, and a non-volatile semiconductor memory including a memory card. Examples of the internal storage device include various devices such as a hard disk, or a semiconductor memory. Moreover, the program code is also able to be executed by downloading from the Internet or executed by receiving from a broadcast wave.

Description has hereinbefore been given for the image display apparatus and the image display system according to the present invention, and as processing procedure has been described, the present invention may also employ a form as a data transfer method in an image display apparatus connected to a plurality of information processing apparatuses in a wired or wireless manner. This data transfer method has a step that a control portion of the image display apparatus controls to receive images to be displayed on screens of the information processing apparatuses for each of the information processing apparatuses in a communication portion of the image display apparatus and display each of the received images on a display portion of the image display apparatus concurrently, a receiving step that an operation portion of the image display apparatus receives a data transfer operation between the information processing apparatuses by an operation for each of the images displayed on the display portion, and a step that the control portion executes data transfer according to the data transfer operation received at the receiving step. Other application examples are as described for the image display apparatus, which description is thus omitted.

Note that, the program code itself is, in other words, a program for causing a computer of the control portion in the image display apparatus connected to the plurality of information processing apparatuses in a wired or wireless manner to execute the processing in this data transfer method (data transfer). That is, this program is a program for executing a step of controlling to receive images to be displayed on screens of the information processing apparatuses for each of the information processing apparatuses and display each of the received images on a display portion of the image display apparatus concurrently, a receiving step of receiving a data transfer operation between the information processing apparatuses by an operation for each of the images displayed on the display portion, and a step of executing data transfer according to the data transfer operation received at the receiving step. Other application examples are as described for the image display apparatus, which description is thus omitted.

Moreover, according to the present invention, in an image display apparatus to which a plurality of information processing apparatuses are connected, it is enabled to make a user recognize a correspondence relation between a transfer source and a transfer destination intuitively at a time of a data transfer operation for performing data transfer between the information processing apparatuses and make the user execute the data transfer with a simple operation.

1. An image display apparatus including a communication portion that communicates with a plurality of information processing apparatuses in a wired or wireless manner, a display portion, and a control portion that controls to receive images to be displayed on screens of the information processing apparatuses for each of the information processing apparatuses in the communication portion and display each of the received images on the display portion concurrently, comprising
an operation portion that receives a data transfer operation between the information processing apparatuses by an operation for each of the images displayed on the display portion.

2. The image display apparatus according to claim 1, wherein
the data transfer operation is an operation for copying or moving of a file or a folder.

3. The image display apparatus according to claim 1, wherein
when the data transfer operation is received by the operation portion, the control portion performs control to transfer data to be transferred through a buffer provided in the image display apparatus.

4. The image display apparatus according to claim 1, wherein
when the data transfer operation is received by the operation portion, the control portion determines a transfer path based on a communication function that is available for the information processing apparatus of a transfer source and the information processing apparatus of a transfer destination, and performs control to transfer data to be transferred through the transfer path.

5. The image display apparatus according to claim 4, wherein
the transfer path is a path that directly connects between the information processing apparatus of the transfer source and the information processing apparatus of the transfer destination or a path that connects between the information processing apparatus of the transfer source and the information processing apparatus of the transfer destination through a buffer provided in the image display apparatus.

6. The image display apparatus according to claim 1, wherein
the operation portion has a touch panel provided in the display portion.

7. A data transfer method in an image display apparatus connected to a plurality of information processing apparatuses in a wired or wireless manner, comprising:
a step that a control portion of the image display apparatus controls to receive images to be displayed on screens of the information processing apparatuses for each of the information processing apparatuses in a communication portion of the image display apparatus and display each of the received images on a display portion of the image display apparatus concurrently,
a receiving step that an operation portion of the image display apparatus receives a data transfer operation between the information processing apparatuses by an operation for each of the images displayed on the display portion, and
a step that the control portion executes data transfer according to the data transfer operation received at the receiving step.

8. A computer-readable non-transitory recording medium having a program to be executed by a computer of a control portion in an image display apparatus connected to a plurality of information processing apparatuses in a wired or wireless manner recorded therein, wherein
the program is for executing
a step of controlling to receive images to be displayed on screens of the information processing apparatuses for each of the information processing apparatuses and display each of the received images on a display portion of the image display apparatus concurrently,
a receiving step of receiving a data transfer operation between the information processing apparatuses by an operation for each of the images displayed on the display portion, and
a step of executing data transfer according to the data transfer operation received at the receiving step.
